(19) United States
(12) Patent Application Publication
(10) Pub. No.: US 2025/0228324 A1
(43) Pub. Date: Jul. 17, 2025

(54) HELMET

(71) Applicant: ABUS August Bremicker Söhne KG, Wetter-Volmarstein (DE)

(72) Inventors: Frank RIEDERER, Dortmund (DE); Marc VON DUNTEN, Essen (DE); Niklas BAUMEISTER, Wuppertal (DE)

(21) Appl. No.: 19/011,686

(22) Filed: Jan. 7, 2025

(30) Foreign Application Priority Data
Jan. 17, 2024 (DE) 102024101337.0

(51) Int. Cl. A42B 3/06

(52) U.S. Cl. CPC A42B 3/06

(57) ABSTRACT

A helmet, which can, for instance, be a sports helmet or a work safety helmet, comprises a helmet body that comprises a solid foam of expanded foam particles, wherein the solid foam at least regionally has a varying hardness.

### CROSS-REFERENCE TO RELATED APPLICATION

This application claims the benefit and priority of German Patent Application No. 102024101337.0 filed on Jan. 17, 2024. The entire disclosure of the above application is incorporated herein by reference.

### FIELD OF THE INVENTION

The invention relates to a helmet, in particular a sports helmet or a work safety helmet.

### BACKGROUND OF THE INVENTION

A helmet serves to protect the respective wearer of the helmet from head injuries in the case of a fall or of an impact of an object on the head of the wearer. Depending on the application, the protective helmet may serve and be configured as a sports helmet or a work safety helmet, for example as a bicycle helmet or a riding helmet. In particular when used as a bicycle helmet, the helmet may have one or more ventilation openings to support a passive cooling of the head of the wearer by environmental air or headwind.

The helmet typically comprises a helmet body that has an at least substantially (for example, only apart from said ventilation openings) concavely shaped inner side, which faces the head of the wearer of the helmet when the helmet is put on, and an at least substantially convexly shaped outer side opposite thereto. The helmet body is adapted in terms of shape, thickness and material to absorb the kinetic energy acting on the helmet during a shock (crash or impact) as much as possible through inelastic and/or elastic deformation. Such shock-absorbing properties may in particular result from the helmet body being made of solid foam.

It is common practice to configure the helmet body according to the so-called in-mold technique by back-injecting a previously separately manufactured outer helmet shell. In principle, however, the helmet body may also be manufactured independently of a helmet shell as a mold body made of solid foam. In both cases, the solid foam is in this respect formed by expanding foam particles of a suitable material within a defined mold. The helmet body may generally be formed entirely by the solid foam. The helmet body may thereby be comparatively easily manufactured as a single molded part.

As a rule, this molded part is then formed largely homogeneously so that different regions of the helmet body at least substantially have the same physical properties, in particular the same shock-absorbing properties. However, it may be expedient if the helmet has different physical properties in different places. Thus, it may, for instance, be sensible if the helmet body may at least predominantly be deformed comparatively easily and largely plastically to be able to absorb as much kinetic energy as possible, but the helmet is nevertheless rather hard at its outer side in order not already to be damaged by minor impacts such that it may no longer be used. Furthermore, it may be expedient to provide regions of the helmet that may be sheared relatively strongly, for instance to be able to absorb torques, and other regions that are relatively rigid with respect to shearing forces, for instance to ensure a stable structure of the helmet.

Providing different regions having different physical properties at a helmet is typically achieved by forming the helmet from a plurality of separately formed elements having different physical properties, wherein, depending on which property is desired in which region of the helmet, a corresponding element is arranged in the respective region.

For example, so that the helmet may be rather hard at its outer side without the entire helmet body having to be correspondingly hard, the helmet may comprise a thin helmet shell that is formed separately from the helmet body, that is composed of a corresponding material (for example an acrylonitrile butadiene styrene copolymer (ABS), polyethylene terephthalate (PET) or a polycarbonate (PC)), that is arranged at the outer side of the helmet body and that at least substantially completely covers the outer side of the helmet body. Or, so that the helmet body may, for example, have different shock-absorbing properties in an edge region than in a central region, the helmet body may be formed in multiple parts, wherein the different parts consist of different materials having different shock-absorbing properties and are joined together after their separate manufacture to jointly form the helmet body.

However, the more parts that have to be manufactured separately and the more different materials that have to be processed and/or machined in different ways for this purpose, the more laborious the overall manufacture of the helmet will be. Furthermore, the recycling of a helmet that comprises many different materials is also more difficult.

### SUMMARY OF THE INVENTION

It is an object of the invention to provide a helmet of the kind mentioned that is particularly well adapted to various requirements and that may nevertheless be manufactured with comparatively little effort and disposed of comparatively easily after its use.

The object is satisfied by a helmet having the features of claim 1. Advantageous embodiments of the invention result from the dependent claims, from the present description, and from the FIGURE.

According to the invention, the helmet, which may in particular be a sports helmet or a work safety helmet, comprises a helmet body that comprises a solid foam of expanded foam particles. In this respect, the helmet body may have an at least substantially concavely shaped inner side, which faces the head of the wearer of the helmet when the helmet is put on, and an at least substantially convexly shaped outer side opposite thereto.

Since the helmet body comprises a solid foam, it may form the central shock-absorbing element of the helmet. The solid foam may generally be elastically deformable (to a certain extent). However, the solid foam is preferably a hard foam so that the solid foam is at least substantially only plastically deformable.

The foam is formed from expanded foam particles. These foam particles, which may at least substantially have a spherical shape, are small particles, in particular so-called foam beads or beads. The foam particles may be pre-foamed, i.e. may already be formed as foam, for example from a microgranulate or directly from the melt of a foamable material, in particular a polymer. In this respect, the foam particles initially have a comparatively dense structure (small cells) and may be caused to expand, in particular by supplying heat.

If a defined space of a certain shape (for example a casting mold for manufacturing the helmet body) is at least largely filled with such foam particles that are not yet (completely) expanded and the foam particles are then caused to expand, they expand into the remaining intermediate spaces, in particular such that they ultimately occupy the entire space. Typically, the expanding foam particles are in this respect pressed against one another so that they adhere to one another, stick together or even fuse. This is also due to the fact that they temporarily lose their solid form during the expansion and become soft.

In this respect, the foam particles may also melt at least partly, in particular if heat is supplied to them for the expansion. The foam particles are preferably joined with one another in a materially bonded manner, in particular by at least partly fusing with one another, as a result of the expansion (and the softening or melting that takes place in the process). The expanded foam particles then (possibly after they have cooled down) form a continuous mold body of solid foam that has the shape of the defined space that acts as a casting mold for forming the solid foam in this regard.

The helmet body comprises at least one such solid foam. The helmet body may generally also comprise a plurality of solid foams that are spatially delineated from one another, possibly manufactured separately from one another. In this respect, it may be provided that all of these foams are formed from expanded foam particles of the same material or that one or more of these foams are formed from expanded foam particles of a different material than one or more other(s) of these foams.

However, the helmet body preferably comprises only a single, continuous solid foam. The helmet body may in particular be formed by the solid foam.

Furthermore, the helmet body may generally comprise other elements in addition to the aforementioned solid foam (and possibly further solid foams). For example, the helmet body may comprise an outer helmet layer and an inner helmet layer (and possibly even further helmet layers), wherein the outer helmet layer is closer to said outer side of the helmet body than the inner helmet layer, in particular comprises the outer side, and the inner helmet layer is closer to said inner side of the helmet body than the outer helmet layer, in particular comprises the inner side, and wherein only one of these helmet layers, in particular the outer helmet layer, comprises the solid foam, in particular is formed by the solid foam.

However, the helmet body is preferably formed in one piece. Therefore, it then does not comprise any further elements formed separately from the solid foam.

It is not exclusively meant that the solid foam is formed from expanded foam particles. Rather, the solid foam may consist of more than just expanded foam particles. For example, other particles, such as fibers for reinforcing the foam, may be embedded in the solid foam.

Any plastic from which expandable foam particles and, therefrom, molded parts may then be produced, may generally be considered in this respect. The helmet body may in particular comprise a solid foam of expanded polystyrene (EPS), expanded polypropylene (EPP), expanded acrylonitrile butadiene styrene copolymer (EABS), expanded polycarbonate (EPC), expanded polyamide (EPA), expanded polybutylene terephthalate (EPBT), expanded polyethylene terephthalate (EPET), expanded modified polyphenylene ether (EmPPE), expanded thermoplastic polyurethane (ETPU), expanded polyoxymethylene (EPOM), expanded polymethyl methacrylate (EPMMA) and/or expanded polyether ketone (EPEK). The solid foam may also be formed from a mixture of foam particles of two or more of the substances mentioned.

According to the invention, it is further provided that the solid foam at least regionally has a varying hardness. The varying hardness may furthermore be accompanied by a varying strength and/or stiffness of the solid foam.

A peculiarity of the helmet according to the invention is therefore that the helmet body is not formed homogeneously, in particular with respect to the physical property of hardness, but is rather formed from a solid foam having a regionally varying hardness. This makes it possible to individually adapt different regions of the helmet body in terms of their hardness to the requirements or desired properties present in the respective region. In this way, the helmet body may also take on tasks that would otherwise be performed by other elements of the helmet. Furthermore, the helmet body may in this respect be formed in one part and may nevertheless have a wide range of properties overall that would otherwise have to be distributed to a plurality of parts of the helmet body.

The solid foam may in this respect generally be produced in the manner described, namely by expanding foam particles within a defined mold to form a molded body corresponding to the mold, wherein the varying hardness of the solid foam may be achieved by supplying heat to the foam particles at different intensities (quantity and/or speed) in different regions of the mold. In other words, the foam particles are heated more and/or faster in one or more regions of the mold than in one or more other regions of the mold. For this purpose, it may in particular be expedient to supply the heat in the form of infrared radiation that may be controlled with comparative spatial precision. For example, the solid foam may be produced according to one of the ways described in WO 2017/109079 A1.

According to an advantageous embodiment, the solid foam is formed from the same material or the same material composition throughout. If the solid foam consists of a plurality of materials, it is therefore formed from an at least substantially homogeneous mixture; if the solid foam comprises only a single material, this material is homogeneously distributed in any case. The fact that different regions of the solid foam have different hardnesses, therefore cannot result from the different regions having different material compositions. Rather, the regionally varying hardness preferably results (exclusively) from the process of forming the solid foam, in particular from how the foam particles from which the solid foam is formed are caused to expand in different ways in different regions, namely preferably (inter alia) by heating by means of infrared radiation, wherein heat is supplied at different intensities to the different regions (cf. the preceding paragraph).

Since the solid foam at least regionally has a varying hardness, there are different regions of the solid foam that differ in their hardness from one another. In particular, the solid foam may comprise at least a first region, which has a first hardness (throughout), and a second region that is different from the first region and that has a second hardness different from the first hardness (throughout). In this respect, the hardness not only varies on a microscopic level, but it may be provided that said first region and said second region each extend in at least one (respective) spatial direction over at least 1 cm, preferably at least 2 cm, in particular at least 3 cm.

The regions of different hardness (for example, said first region and said second region) preferably merge into one another in a materially bonded manner in this respect. In other words, the solid foam which the helmet body comprises is continuous in terms of material even at positions at which its hardness changes, i.e. it does not have an interruption in its material structure.

In contrast, the hardness does not necessarily have to change continuously, but may also change (at least virtually) abruptly between two regions of different hardness. This may in particular be a result of a locally very different thermal effect on the different regions when forming the solid foam. A certain region within the mold in which the solid foam is formed may, for example, be heated particularly strongly compared to an adjoining region (and may thereby differ particularly greatly in its hardness from the adjoining region) in that the foam particles in this region are heated using a heat transfer medium, such as water or preferably a thermal oil, for a precise local temperature control of the foam particles or of the mold.

According to a further advantageous embodiment, the helmet body approximately has a spherical shell shape (i.e. a shape that approximately corresponds to a part of a spherical shell, in particular a hemispherical shell), wherein the hardness of the solid foam varies in the radial direction with respect to a center of the spherical shell shape. The concavely shaped inner side of the helmet body mentioned further above may in this respect be oriented facing radially inwardly, i.e. towards this center, while the convexly shaped outer side of the helmet body may be oriented facing radially outwardly, i.e. away from this center. In this respect, the hardness of the solid foam may in particular vary in the radial direction in that the solid foam has a different hardness in a radially inner region than in a radially outer region (relative to the radially inner region).

According to an advantageous further development, the hardness of the solid foam increases radially outwardly and/or radially inwardly. In other words, it may be advantageous, for example, for the hardness of the solid foam to increase from radially inwardly to radially outwardly, from radially outwardly to radially inwardly or, starting from a radially central region, both radially outwardly and radially inwardly, in particular monotonically (possibly at least virtually abruptly).

In particular, it may be advantageous for the solid foam to have an outer surface layer that bounds the helmet body radially outwardly (with respect to said center of the spherical shell shape), an inner surface layer that bounds the helmet body radially inwardly, and a core that is arranged between the outer surface layer and the inner surface layer, wherein the hardness of the outer surface layer and/or the hardness of the inner surface layer is/are greater than the hardness of the core. One or more further layers and/or transition regions between different layers may in this respect be formed between the core and the outer and/or inner surface layer. Since the solid foam has such a harder surface layer compared to a core of the solid foam, it may advantageously be made possible to dispense with the provision of a separate helmet shell for protecting the helmet body at the corresponding side (outer side or inner side) of the helmet body.

According to a further advantageous embodiment, the helmet body approximately has a spherical shell shape (i.e. a shape that approximately corresponds to a part of a spherical shell, in particular a hemispherical shell, in particular the spherical shell shape mentioned in relation to the above-mentioned embodiments), wherein the hardness of the solid foam varies in the tangential direction (i.e. revolving around the center M) with respect to a center of the spherical shell shape.

In particular, it may be advantageous for the hardness of the solid foam to be greater at ends of the tangential extent of the helmet body than in regions therebetween. In principle, however, it may also be the other way round so that the hardness of the solid foam is smaller at ends of the tangential extent of the helmet body than in regions therebetween.

Said ends of the tangential extent of the helmet body may in particular comprise or be formed by a circumferential edge of the helmet body. This edge may connect said outer side of the helmet body to said inner side of the helmet body and may extend once around the entire helmet body in so doing. In this respect, it is particularly advantageous if such an edge has a different, in particular greater, hardness than an inner region of the helmet body (arranged inside the edge and spaced apart from the ends of the tangential extent of the helmet body) that may correspond to said core.

If the helmet has ventilation openings that also extend through the helmet body, it may further be expedient if the helmet body has a different, in particular greater, hardness in regions that adjoin ventilation openings (possibly including the edges of the ventilation openings), in particular enclose them, than in regions further away from the ventilation openings, such as said core of the helmet body.

In particular, it is advantageous if the hardness of the solid foam varies with respect to said center of the spherical shell shape both in the radial direction and in the tangential direction, wherein the hardness of the solid foam at said outer surface layer and said inner surface layer and at ends of the tangential extent of the helmet body are, for example, greater than the hardness in regions therebetween, in particular than the hardness of said core. In this way, the helmet body may largely have a solid shell outwards and, at the same time, a core that is optimized with respect to the greatest possible shock absorption without having to be formed in multiple parts or from a plurality of different materials for this purpose.

### DRAWINGS

The invention will be explained further in the following merely by way of example with reference to the FIGURE that shows one embodiment of the helmet according to the invention in a sectional representation.

### DESCRIPTION OF THE INVENTION

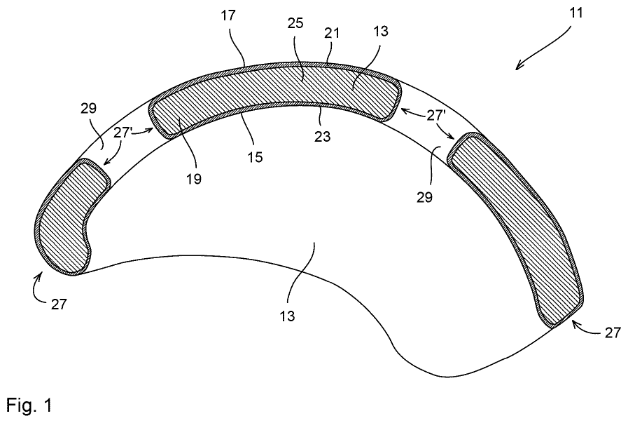

The helmet 11 of the embodiment shown in FIG. 1 is a bicycle helmet that is shown in a highly simplified sectional representation. In particular, only a helmet body 13 of the helmet 11 is shown in FIG. 1, wherein the helmet 11 may also comprise further elements, such as straps for its fastening, padding for a comfortable fit on the head of the respective wearer, etc.

The helmet body 13 approximately has a spherical shell shape and consequently a concavely shaped inner side 15 and a convexly shaped outer side 17. In this respect, the helmet 11 is configured to be placed on the head of a wearer, wherein the inner side 15 of the helmet body 13 faces the head or contacts it and the outer side 17 of the helmet body 13 faces away from the head. The helmet 11 further has a plurality of ventilation openings 29 that each extend through the helmet body 13 in a substantially radial direction (with respect to a center of said spherical shell shape).

The helmet body 13 comprises a solid foam 19. The helmet body 13 is in particular formed from the solid foam 19. According to the invention, the solid foam 19 in this respect has an at least regionally varying hardness.

In the embodiment shown, the hardness of the solid foam 19 in particular varies in that the solid foam has an outer surface layer 21, an inner surface layer 23 and a core 25, and the hardness of the outer surface layer 21 and the inner surface layer 23 is greater than the hardness of the core 25. The outer surface layer 21 bounds the helmet body 13 radially outwardly (with respect to a center of said spherical shell shape), while the inner surface layer 23 bounds the helmet body 13 radially inwardly. The core 25 is arranged between the outer surface layer 21 and the inner surface layer 23.

Due to this configuration, the hardness of the solid foam 19 varies in the radial direction. Furthermore, the hardness of the solid foam 19 also varies in the tangential direction. This is because the hardness of the solid foam 19 is greater at the ends of the tangential extent of the helmet body 13, which form a circumferential edge 27 of the helmet body 13, than in regions therebetween, in particular greater than the hardness of said core 25 of the helmet body 13.

Furthermore, the tangential extent of the helmet body 13 is also interrupted by said ventilation openings 29. In this respect, the solid foam 19 in each case also has a greater hardness in the region of a circumferential edge 27′ of the respective ventilation opening 29 than in regions further away from the ventilation openings 29, in particular a hardness that is greater than the hardness of the core 25 of the helmet body 13. In this respect, these regions of different hardness (the surface layers 21, 23, the core 25 and the circumferential edges 27, 27′) are not mutually separate parts of the helmet body 13, but advantageously consist of the same material and merge into one another in a materially bonded manner so that the helmet body 13 is formed in one piece overall.

In the embodiment shown, the outer surface layer 21, the inner surface layer 23, the circumferential edge 27 of the helmet body 13 and the circumferential edges 27′ of the ventilation openings 29 each have the same hardness that is greater than the hardness of the core 25 of the helmet body 13. Furthermore, the circumferential edges 27, 27′ in each case connect the outer surface layer 21 and the inner surface layer 23 to one another and in so doing merge seamlessly into the respective surface layer 21 or 23. The surface layers 21, 23 and the circumferential edges 27, 27′ thereby together form an overall surface layer of the helmet body 13 that completely encloses the core 25 of the helmet body 13 and thus outwardly bounds the helmet body 13.

In this way, the helmet body 13 may have a hardness in its core 25 that is suitable for a good absorption of large impacts, such as may, for instance, occur during a fall, and it may simultaneously have a greater hardness compared thereto at its surface that protects it from minor damage during normal use of the helmet 11. Furthermore, the core 25 does not necessarily have to have the same hardness throughout. Rather, one or more sections of the core 25 may have a different hardness than the rest of the core 25 and/or one or more other regions of the helmet body 13 different from the core 25 may have a different hardness than the core 25. As a result, it is possible, for example, for the helmet body 13, in particular the core 25 of the helmet body 13, to have different shock-absorbing properties at different positions that are each specifically adapted to the type of shocks that typically occur at the respective position in the event of an impact or collision.

Due to the embodiment according to the invention, the helmet 11 may therefore provide particularly reliable protection. In this respect, it may simultaneously be manufactured with comparatively little effort since the helmet body 13 does not have to be formed from a plurality of separate parts despite the different shock-absorbing properties in different regions of the helmet 11.

What is claimed is:

1. A helmet, comprising a helmet body that comprises a solid foam of expanded foam particles, wherein the solid foam at least regionally has a varying hardness.

2. The helmet according to claim 1, wherein the solid foam is formed from the same material or the same material composition throughout.

3. The helmet according to claim 1, wherein regions of different hardness merge into one another in a materially bonded manner.

4. The helmet according to claim 1, wherein the helmet body approximately has a spherical shell shape, and wherein the hardness of the solid foam varies in a radial direction with respect to a center of the spherical shell shape.

5. The helmet according to claim 4, wherein the hardness of the solid foam increases radially outwardly and/or radially inwardly.

6. The helmet according to claim 4, wherein the solid foam has an outer surface layer that bounds the helmet body radially outwardly, an inner surface layer that bounds the helmet body radially inwardly, and a core that is arranged between the outer surface layer and the inner surface layer, and wherein at least one of the hardness of the outer surface layer or the hardness of the inner surface layer is greater than the hardness of the core.

7. The helmet according to claim 1, wherein the helmet body approximately has a spherical shell shape, and wherein the hardness of the solid foam varies in a tangential direction with respect to a center of the spherical shell shape.

8. The helmet according to claim 7, wherein the hardness of the solid foam is greater at ends of a tangential extent of the helmet body than in regions therebetween.

9. The helmet according to claim 7, wherein the hardness of the solid foam is smaller at ends of a tangential extent of the helmet body than in regions therebetween.

10. The helmet according to claim 1, wherein the helmet is configured as a sports helmet or a work safety helmet.
